(19) United States
(12) Patent Application Publication
(10) Pub. No.: US 2007/0049661 A1
(43) Pub. Date: Mar. 1, 2007

(54) Agricultural stalk strandboard

(75) Inventors: Thomas Neel, Panora, IA (US); David W. Thompson, Kelowna (CA); Timothy McDermott, Jamaica, IA (US); William Priestley, Guthrie Center, IA (US); Barry Monagham, Guthrie Center, IA (US)

Correspondence Address: MCKEE, VOORHEES & SEASE, P.L.C., 801 GRAND AVENUE, SUITE 3200, DES MOINES, IA, 50309-2721, US

(73) Assignee: PreMoMcNe, LLC, Panora, IA (US)

(21) Appl. No.: 11/213,180

(22) Filed: Aug. 26, 2005

(51) Int. Cl. C08L 5/00

(52) U.S. Cl. 524/27

(57) ABSTRACT

The process described herein presents a unique method and means of manufacturing strandboard using agricultural plant stalks. The plant stalks are first depithed and excess moisture is removed. The stalks are then combined with a resin component and a wax component, and the resulting mixture is cured. The strandboard is economical to manufacture than prior art strandboard in that it does not require the use of expensive MDI resin. Further, the strandboard is environmentally friendly in that it provides a beneficial use for agricultural waste.

### FIELD OF THE INVENTION

This invention relates to the use of agricultural waste product, namely agricultural stalks, in the manufacture of strandboard.

### BACKGROUND OF THE INVENTION

Economic growth and development worldwide have generated unprecedented needs for converted forest products. While the energy needs of developing countries have created ever-increasing demands for fuelwood, global fiber production systems have demonstrated the capability to meet these demands in the aggregate. Regardless, there are some serious local/regional fiber shortages and resource management conflicts.

People worldwide have become increasingly concerned about the future of forests, their health, wildlife diversity, productivity for wood, environmental roles, and aesthetics. As a result of these concerns, the practices of forestry are changing, resulting in iodized wood fiber supply shortages. In addition, many developing countries around the world do not have adequate forest reserves to cover their needs for fuelwood, industrial wood, sawn wood, wood-based building components, etc. However, many of these countries do have relatively large quantities of other materials available in the form of agricultural residues from annual crops. There is therefore an increasing interest in using agricultural fibers for building components, either to complement or replace wood.

Conventional methods of handling agricultural waste, such as waste hay and other plant stalks, include using the same as animal bedding material or compost. Alternatively, the waste is tilled back into the ground with little or no benefit to the soil. The invention presented herein presents an environmentally friendly, economically viable permanent solution for disposing of agricultural waste that further provides a new, renewable source of building components.

Accordingly, it is a primary objective of the present invention to provide a novel method and means of processing and recycling agricultural waste materials.

It is a further objective of the present invention to provide an economical method and means of processing and recycling agricultural waste materials.

It is still a further objective of the present invention to provide a novel method and means of processing and recycling agricultural waste materials resulting in a building product, namely structural strandboard.

It is yet a further objective of the present invention to provide a novel method and means of producing strandboard that does not require the use of expensive resin.

It is a further objective of the present invention to provide a novel method and means of producing strandboard that is relatively non-toxic.

It is still a further objective of the present invention to provide a novel method and means of producing strandboard without the use of wood materials.

The method and means of accomplishing each of the above objectives as well as others will become apparent from the detailed description of the invention which follows hereafter.

### SUMMARY OF THE INVENTION

The present invention describes the first strandboard incorporating non-wood plant straw and a phenol formaldehyde (PF) resin or other types of resins, such as UF, melamine, and soy resins, without the need for expensive MDI resin. The strandboard is produced by removing the pith of plant stalks, cutting the stalks to the desired length, and drying them to a moisture content of 4% or less by weight. The plant stalks are then coated with phenol formaldehyde or resins and a wax emulsion. The coated stalks are next placed under sufficient heat and pressure to set the resin, and then formed into a mat.

The strandboard of the present invention provides an economical means of recycling agricultural waste material. Further, as already noted, the strandboard of the invention is environmentally friendly in that it uses inexpensive, non-wood sources. In addition, the strandboard is less toxic and expensive than previous strandboards that require the use of MDI resin.

### BRIEF DESCRIPTION OF THE DRAWINGS

FIG. 1 illustrates a pressing schedule and plotted characteristics of the resulting mat from a trial run using soy fiber and the processing conditions of the present invention performed Jun. 3, 2005 at 13:36:42.

FIG. 2 illustrates a pressing schedule and plotted characteristics of the resulting mat from a trial run using soy fiber and the processing conditions of the present invention performed Jun. 3, 2005 at 13:55:53.

FIG. 3 illustrates a pressing schedule and plotted characteristics of the resulting mat from a trial run using soy fiber and the processing conditions of the present invention performed Jun. 3, 2005 at 14:04:05.

FIG. 4 illustrates a pressing schedule and plotted characteristics of the resulting mat from a trial run using soy fiber and the processing conditions of the present invention performed Jun. 3, 2005 at 14:42:49.

FIG. 5 illustrates a pressing schedule and plotted characteristics of the resulting mat from a trial run using soy fiber and the processing conditions of the present invention performed Jun. 3, 2005 at 14:50:29.

FIG. 6 illustrates a pressing schedule and plotted characteristics of the resulting mat from a trial run using soy fiber and the processing conditions of the present invention performed Jun. 3, 2005 at 15:23:56.

FIG. 7 illustrates a pressing schedule and plotted characteristics of the resulting mat from a trial run using soy fiber and the processing conditions of the present invention performed Jun. 3, 2005 at 15:31:54.

FIG. 8 illustrates a pressing schedule and plotted characteristics of the resulting mat from a trial run using soy fiber and the processing conditions of the present invention performed Jun. 3, 2005 at 15:54:05.

### DETAILED DESCRIPTION OF THE PREFERRED EMBODIMENT

The present invention relates to the development of an economical, efficient, and non-toxic method of producing a structural strandboard from non-wood, plant waste materials. The strandboard can be made of any plant stalks that do not have a waxy outer cuticle, such as soybean and cotton, bagasse stalks, rice, bamboo, etc.

The first step in the process is to remove the pith from the plant stem or stalk. Removal of the pith prior to treatment is necessary since otherwise the pith will absorb most of the resin used in forming the strandboard. Various means are known in the art for depithing plant stalks, including the apparatuses described in U.S. Pat. Nos. 4,202,078 and 4,231,529, as well as use of knives, blades, pressure rollers, etc. The pith may also be removed using the machine described in the inventors' co-pending application describing a depithing machine, Ser. No. ______, the disclosure of which is hereby expressly incorporated by reference. The depithing process will preferably longitudinally split the plant stem to enable coating of all surfaces of the plant fiber with the resin in the later step.

The depithed stalks are next cut to the desired length for application in strandboard, which will generally range from about 4-8 inches. The strands are then preferably screened using conventional methods to remove any remaining pith, fines and powder which tend to absorb too much of the resin. The fines and powder removed can in turn be used as fuel for dryers in the following step.

The stalks are then dried to a moisture content of about 4% or less. While it is possible to have higher moisture content and achieve a workable final product, moisture content of greater than about 4% is not preferred since moisture content above this level will result in a weaker final product and/or delamination, blows, etc. Rotary dryers are commonly used in this step, with both single and triple-pass dryers being used. The dryers may be agriculture waste-fired, gas-, or oil-fired. Dryer inlet temperatures will generally range between about 1000-1200° F. (about 535°-650° C.), with about 1100° F. (593° C.) being preferred. The stalks are typically dried for a time period of about 1-2 minutes, or at a temperature and for time period sufficient to reduce the moisture content of the materials to the desired level, and preferably to a moisture content of about 4% or less by weight. The drying time and/or temperature may be adjusted according to the temperature and the moisture content of the input materials. The moisture in the stems may also be removed using other conventional means known in the art including, but not limited to, centrifugation and air drying. Persons skilled in the art can readily appreciate such additional methods.

After drying, the fibers are typically transferred to holding bins, from which the core and surface materials are transferred to blenders in which at least a resin and a wax emulsion are applied to the materials, preferably by means of spray nozzles, tubes, or atomizers. Typically, about 60% of the fiber material is core, with the remaining 40% being face material. This separate face-core blending system allows different percentages and additives of resin which enhance the pressing and bonding cycles. This invention of adding soy resins to the blending process also results in much lower formaldehyde emissions in the finished product.

The present invention preferably incorporates a phenol formaldehyde (PF) resin. PF resin is a relatively inexpensive, red/black-colored resin that is used in pressed wood products such as softwood plywood and flake or oriented strandboard for exterior applications. PF resin cannot be used alone in the manufacture of strandboard incorporating cereal straws since the PF resin will not bind to the waxy outer layer of such straws. Thus, until now, it was not believed that PF resin was feasible for use in the manufacture of structural strandboard.

MDI isocyanate is a relatively new and very efficient resin, due to the fact that it makes a molecular, not just an adhesive, bond. This feature also has drawbacks, however, in that the resin can stick firmly to metal and various parts of the human anatomy. Workers must also take great care in the production of the resin itself, as it is highly toxic and difficult to handle. The hazards of MDI are enhanced by the fact that it is highly volatile and has no odor. Other drawbacks to MDI are that it is more expensive than formaldehyde resins and it is shipped in liquid form. The cost of MDI has risen substantially in recent years.

The present inventors surprisingly determined that PF resin can be used in the production of strandboard using agricultural straw without the concurrent use of MDI resin. The strandboard can therefore be manufactured with less risk of toxicity and at a substantially lower cost. Urea formaldehyde (UF) resin may also be used in accordance with the methods of this invention in the manufacture of strandboard for internal applications. The present invention also contemplates that various other resins may added to the primary formaldehyde resin used, such as melamine, soy-based resins, and even MDI. Resins that combine a majority of soy protein and a formaldehyde are known in the art. Some that include UF or PF have recently been produced by Heartland Resource Technologies (HRT), and are suitable for use in this invention.

If included, such resins should generally constitute no more than about 12% by weight of the total resin concentration, with about 10-12% by weight being preferred. Preferred strandboards of this invention include less than 50% MDI resin by total weight of the resin, or less than 10% by weight of the strandboard, with less than 5% by weight of the strandboard being more preferred, with the majority of the resin component comprising a formaldehyde resin for reasons of safety and economy. Most preferred strandboards are substantially free of MDI resin, again for reasons of safety and economy. As used herein, “substantially free of MDI resin” means the resin does not include detectable amounts of MDI resin.

The PF or other resin is applied to the stalks in a concentration of at least 5% by weight of the fiber, with about 5-10% by weight being preferred. More than 10% by weight resin can be included, but any more than about 12% by weight will not provide additional benefit to the final product, and may result in too much moisture in the product. The core materials are also preferably blended with a curing accelerator/catalyst, such as melamine. Such curing accelerators/catalysts for this purpose are well known to persons skilled in the art.

Waxes are added to impart water resistance and to assist in dispersing the resin on all surfaces of the fibers. A wax emulsion is also preferably applied to the stalks along with the resin in a concentration of at least 0.5% by weight of the fiber. Wax emulsions are well known in the art and include, but are not limited to, synthetic amide, carnauba, carnauba/micro, carnauba/paraffin, carnauba/PE, EAA, microcrystalline, paraffin, paraffin/EAA, paraffin/micro, paraffin/PE, polyethylene, polypropylene, scale, beeswax, lanolin, lanocerin, shellac, ozokerite, candelila, jojoba, ouricouri, montan, intermediate, etc. Various manufacturers of wax emulsions are Michem®, Paracol®, and Microlube®. A preferred concentration of wax emulsion is between about 0.5-2% by weight. Once the concentration of emulsion exceeds 2%, the materials tend to become too wet, and therefore amounts greater than 2% by weight are not preferred.

Other miscellaneous ingredients may be included in the strandboard depending upon the product specification. Such ingredients may include, but are not limited to coloring agents, lubricants, borax or other fire retardants, etc. If included, these minor ingredients generally will not constitute more than 2% by weight of the strandboard.

Blenders are generally used to discharge the resinated materials into a plenum over a belt conveyor that feeds the blended material to a forming machine, which deposits the resinated material in the form of a continuous mat. Formers use air to convey the material, which is cross-oriented between the forming heads. To produce multilayer strandboard, several forming heads can be used in a series. As it leaves the former, the mat may be prepressed to a depth of about 10-12 inches prior to trimming and pressing. The mats are then cut into the desired lengths and conveyed to the press.

The press applies heat and pressure to activate the resin and bond the fibers into a solid board. Although some single-opening presses are used, most strandboard plants are equipped with multi-opening batch presses. The press time generally ranges between about 3-9 minutes. Continuous presses may also be used to produce the strandboard. Presses generally are heated using steam. However, hot oil and hot water may also be used to heat the press. The operating temperature for the presses generally range from about 300-360° F. (149-182° C.), with about 320-340° F. being preferred. Typically, the pressure will range from about 3000-3500 psi, with about 3200 psi being preferred. The press temperature, pressure, and time will vary according to the molded product being produced. The final product is pressed to a depth that will generally range from about ⅜ to 1.25 inches. The product will be of varying densities depending on the specifications of the buyer.

After pressing, the boards are generally cooled prior to stacking. The strandboards are then sanded and/or trimmed to the final desired dimensions, any other finishing operations (such as laminate or veneer application) are done, and the finished product is packaged for shipment. Unlike other agricultural panels, the strandboard of this invention may be used as a structural strandboard, as well as for non-structural applications, i.e. as fiberboard or particleboard for use in furniture.

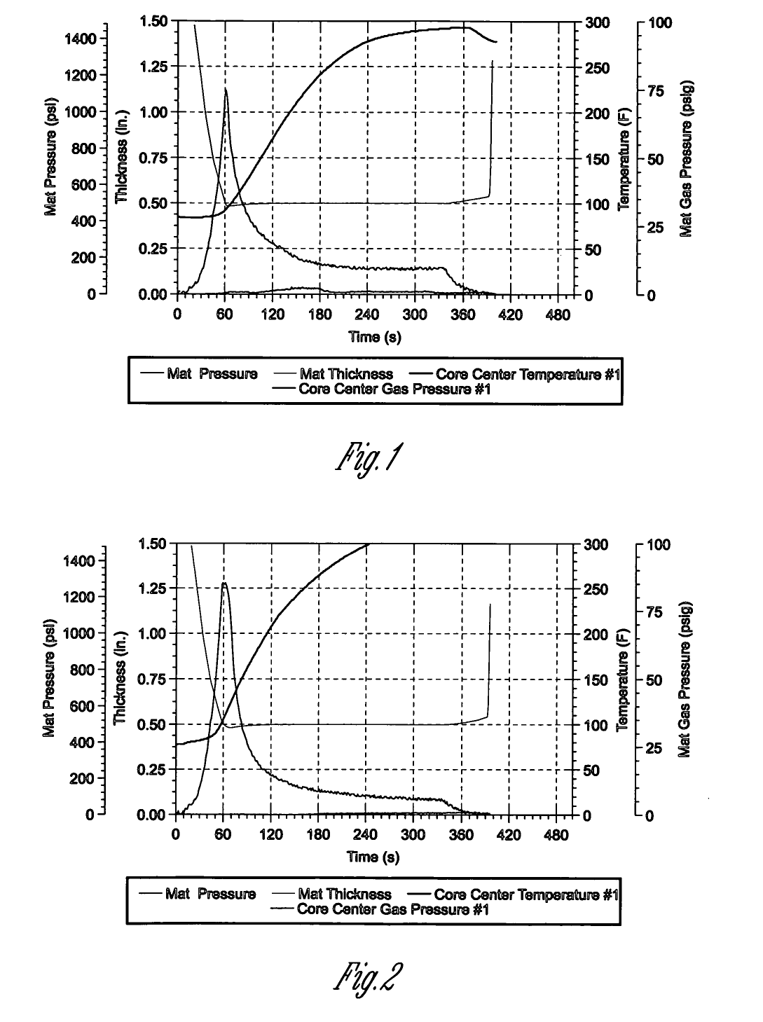

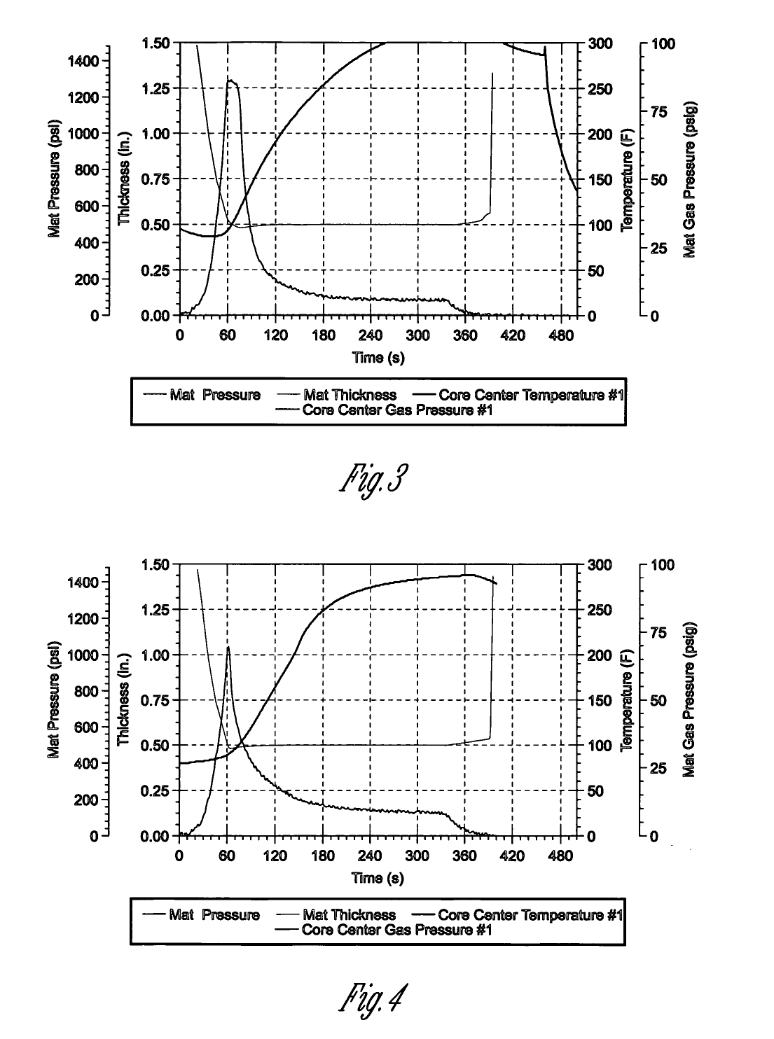

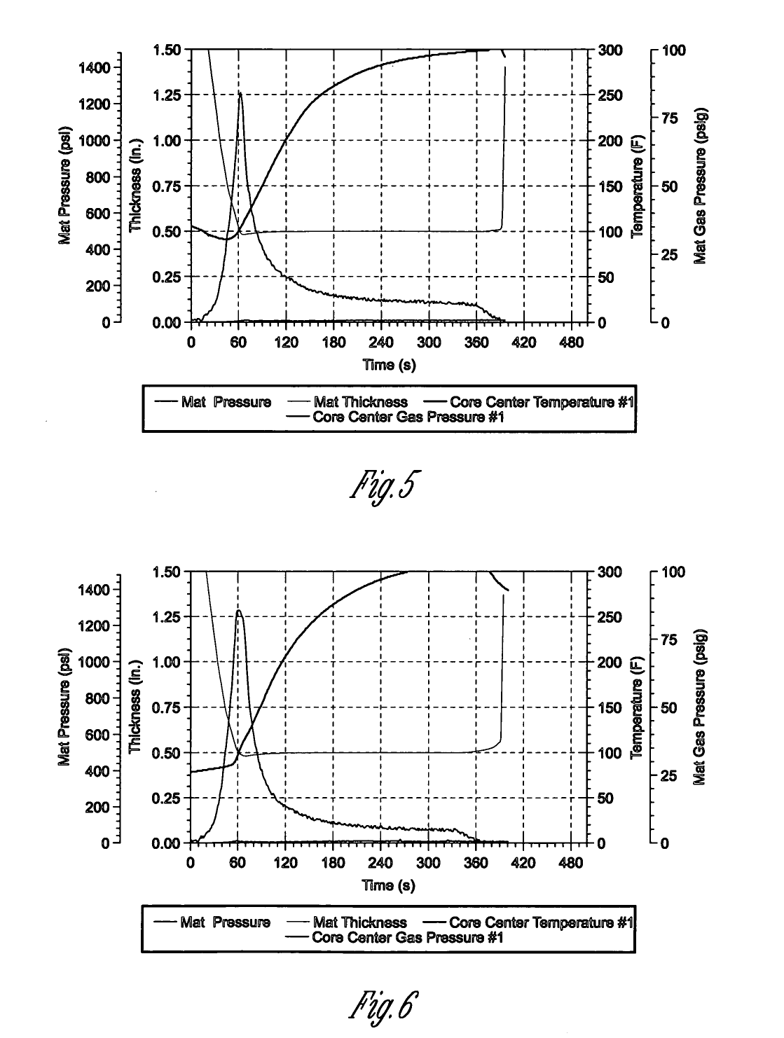

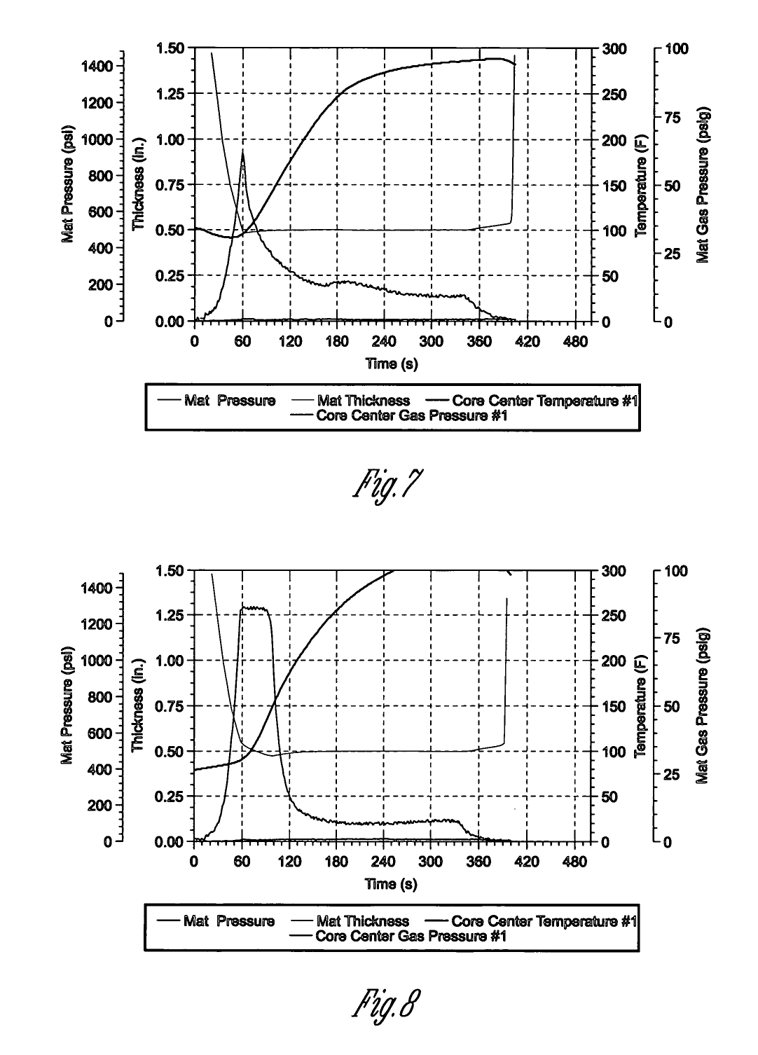

FIGS. 1-8 illustrate pressing schedules, plots and the internal bonds test results of 8 trial runs using soy fiber and the processing conditions of the present invention.

Persons skilled in the art will readily understand that the processes described above may be performed in a one-step process, or in several steps. In the alternative, the process of this invention may take place in several steps and in numerous chambers or containers in a factory or manufacturing process. Persons skilled in the art will also readily appreciate that the processes of this invention may be accomplished using a variety of equipment and techniques that are well known in the art, including conveyor belts, chambers, condensers, centrifuges, distillers,, etc. The specific equipment used is not critical to the process.

It should be appreciated that minor modifications of the composition and the ranges expressed herein may be made and still come within the scope and spirit of the present invention.

Having described the invention with reference to particular compositions, theories of effectiveness, and the like, it will be apparent to those of skill in the art that it is not intended that the invention be limited by such illustrative embodiments or mechanisms, and that modifications can be made without departing from the scope or spirit of the invention, as defined by the appended claims. It is intended that all such obvious modifications and variations be included within the scope of the present invention as defined in the appended claims. The claims are meant to cover the claimed components and steps in any sequence which is effective to meet the objectives there intended, unless the context specifically indicates to the contrary.

What is claimed is:

1. A strandboard, comprising:
plant stalks that do not have a cuticle;
a thermal resin component, said strandboard comprising less than 10% by weight MDI resin.

2. The strandboard of claim 1 whereby the plant stalks are selected from the group consisting of soy, cotton, bagasse, bamboo, rice, and mixtures of the same.

3. The strandboard of claim 1 whereby the strandboard comprises less than 5% by weight MDI resin.

4. The strandboard of claim 1 whereby the resin component is substantially free of MDI resin.

5. The strandboard of claim 1 further including a wax.

6. The strandboard of claim 1 comprising from about 5-10% by weight of the resin component.

7. The strandboard of claim 4 comprising between about 0.5-2.0% by weight wax.

8. A method of manufacturing strandboard from agricultural waste, comprising:
depithing plant stalks, said plant stalks not having a cuticle;
reducing the moisture content of the stalks to form dried material;
applying a thermal resin component and at least one wax component to the dried material, said resin component comprising less then 50% by weight NMI resin; and
curing the resin to form a strandboard.

9. The method of claim 8 whereby the plant stalks are split longitudinally during the depithing step.

10. The method of claim 8 further including the step of cutting the strands to a length of about 4-8 inches per strand.

11. The method of claim 8 further including the step of screening the stalks to remove remaining pith, fines, or powder.

12. The method of claim 8 whereby the stalks are dried to a moisture content of about 4% by weight or less.

13. The method of claim 8 whereby the dried material forms core and surface materials onto which the resin and wax component are applied.

14. The method of claim 13 whereby the core material is blended with a curing accelerator.

15. The method of claim 8 whereby the resulting strandboard comprises less than 10% by weight MDI resin.

16. The method of claim 10 whereby the resin component comprises a majority concentration of formaldehyde resin.

17. The method of claim 8 further including the step of pressing the dried material prior to the curing step.

18. The method of claim 8 whereby the curing step is performed at a temperature ranging from about 300-360° F.

19. The method of claim 8 whereby the curing step is performed for about 3-9 minutes.

20. The method of claim 8 whereby the curing step is performed at a pressure ranging from about 3000-3500 psi.

21. The method of claim 8 further including the step of cooling the strandboard following the curing step.

22. Strandboard manufactured in accordance with claim 8.

23. A strandboard comprising:
plant stalks that do not have a cuticle;
a thermal resin component, said strandboard being substantially free of MDI resin.
